(19) United States
(12) Patent Application Publication
(10) Pub. No.: US 2019/0316608 A1
(43) Pub. Date: Oct. 17, 2019

(54) HYDRAULIC ACTUATOR

(71) Applicant: BRIDGESTONE CORPORATION, Tokyo (JP)

(72) Inventors: Atsushi NAKAYAMA, Higashiyamato-shi, Tokyo (JP); Yasunori TARUTANI, Kokubunji-shi, Tokyo (JP); Shingo OHNO, Higashimurayama-shi, Tokyo (JP); Yasuo FUKUSHIMA, Kodaira-shi, Tokyo (JP)

(73) Assignee: BRIDGESTONE CORPORATION, Tokyo (JP)

(21) Appl. No.: 16/347,719

(22) PCT Filed: Oct. 30, 2017
(86) PCT No.: PCT/JP2017/039199

§ 371 Date: May 6, 2019

(30) Foreign Application Priority Data
Nov. 7, 2016 (JP) 2016-217533
May 19, 2017 (JP) 2017-099998

(51) Int. Cl. F15B 15/10; F15B 15/14

(52) U.S. Cl. CPC F15B 15/10; F15B 15/1433; F15B 15/1438

(57) ABSTRACT

Provided is a hydraulic actuator having a tube with improved durability, the hydraulic actuator (10), having an actuator main body (100) constituted of a cylindrical tube (110) capable of expanding/contracting by hydraulic pressure and a cylindrical sleeve (120) formed by cords woven to be disposed in predetermined directions, wherein: the tube (110) has a laminated structure including two or more rubber layers, the rubber layers being constituted of at least one polar rubber layer (111) containing, with respect to a rubber component(s), ≥50 mass % of a polar rubber of which SP value is ≥8.7 and at least one non-polar rubber layer (112) containing, with respect to a rubber component(s), <50 mass % of a polar rubber of which SP value is ≥8.7.

### TECHNICAL FIELD

The present invention relates to a hydraulic actuator.

### BACKGROUND ART

Conventionally, there has been widely used as an actuator for expanding/contracting a tube a pneumatic actuator having a rubber tube (a tube-shaped body) capable of expanding/contracting by using air as working fluid and a sleeve (a woven reinforcing structure) covering an outer peripheral surface of the tube, i.e. a McKibben type actuator (refer to PTL1, for example).

Respective end portions of an actuator main body constituted of a tube and a sleeve as described above are caulked by using a sealing member formed by metal.

The sleeve is a cylindrical structure formed by woven high tensile strength fiber cords such as polyamide fibers or metal cords, for regulating expansion movements of the tube within a predetermined range.

Such a pneumatic actuator as described above, which is used in various fields, is suitably used as an artificial muscle for a nursing care/healthcare device in particular.

### CITATION LIST

### Patent Literature

PTL 1: JP S61-236905 A

### SUMMARY

### Technical Problem

However, such a conventional actuator as described above using air as working fluid does not have particularly high strength (pressure resistance), which strength is only around 0.5 MPa at most, for example.

In this respect, durability of the conventional actuator is not satisfactory when it is employed as a hydraulic actuator using liquid such as oil, water or the like as working fluid because a hydraulic actuator is generally subjected to high pressure, e.g. 50 MPa. In particular, a tube adjacent to a sleeve of the conventional actuator bears relatively large load because of repeated expansion-contraction motions of the actuator, thereby necessitating further improvement in terms of durability of the tube.

In view of this, an object of the present disclosure is to solve the prior art problems described above and provide a hydraulic actuator using liquid as working fluid, and having a tube which exhibits improved durability.

### Solution to Problem

Primary features of the present disclosure for achieving the aforementioned object are as follows.

A hydraulic actuator of the present disclosure has an actuator main body constituted of a cylindrical tube capable of expanding/contracting by hydraulic pressure and a sleeve for covering an outer peripheral surface of the tube, the sleeve having a cylindrical structure formed by cords woven to be disposed in predetermined directions, wherein:

the tube has a laminated structure including two or more rubber layers, the rubber layers being constituted of at least one polar rubber layer containing, with respect to a rubber component(s) thereof, ≥50 mass % of a polar rubber of which SP value is ≥8.7 and at least one non-polar rubber layer containing, with respect to a rubber component(s) thereof, <50 mass % of a polar rubber of which SP value is ≥8.7.

The hydraulic actuator according to the present disclosure exhibits improved durability of a tube thereof and thus has high durability as an actuator.

In the present disclosure, SP (solubility parameter) value of a rubber component such as a polar rubber, a non-polar rubber and the like is calculated according to Fedors' method. The unit of the SP value is “(cal/cm³)^{1/2}”.

In the present disclosure, a rubber having SP value ≥8.7 is defined as a “polar rubber” and a rubber having SP value <8.7 is defined as a “non-polar rubber”.

Further, in the present disclosure, a rubber layer containing, with respect to a rubber component(s) thereof, ≥50 mass % of a polar rubber of which SP value is ≥8.7 is defined as a “polar rubber layer” and a rubber layer containing, with respect to a rubber component(s) thereof, <50 mass % of a polar rubber of which SP value is ≥8.7 is defined as a “non-polar rubber layer”.

In a preferable example of the hydraulic actuator of the present disclosure, the polar rubber layer is provided on the innermost side of the tube. In this case, oil resistance of the tube improves, whereby durability of the tube further improves.

In another preferable example of the hydraulic actuator of the present disclosure, the non-polar rubber layer is provided on the outer side in the radial direction of the polar rubber layer and on the outermost side of the tube. In this case, strength of the tube enhances, whereby durability of the tube further improves.

In yet another preferable example of the hydraulic actuator of the present disclosure, the polar rubber layer contains acrylonitrile-butadiene rubber and/or hydrogenated acrylonitrile-butadiene rubber. In this case, oil resistance of the polar rubber layer improves, whereby durability of the tube further improves.

In this respect, it is preferable that the acrylonitrile-butadiene rubber and/or the hydrogenated acrylonitrile-butadiene rubber contains acrylonitrile units therein by 20 mass % to 50 mass %. In this case, oil resistance of the polar rubber layer further enhances, whereby durability of the tube further improves.

Further, it is preferable that the acrylonitrile-butadiene rubber and/or the hydrogenated acrylonitrile-butadiene rubber include at least two types of acrylonitrile-butadiene rubber and/or hydrogenated acrylonitrile-butadiene rubber having different contents of acrylonitrile units therein. In this case, the content of acrylonitrile units in the polar rubber layer can be easily adjusted to a desired value.

In the hydraulic actuator of the present disclosure, it is preferable that the polar rubber layer contains a non-polar diene-based rubber having SP value less than 8.7. In this case, strength of the polar rubber layer enhances, whereby durability of the tube further improves.

In the hydraulic actuator of the present disclosure, the polar rubber layer has the weighted average nitrile content in the rubber component(s), which is preferably in the range of ≥20% and ≤45%. In this case, oil resistance of the polar rubber layer enhances, whereby durability of the tube further improves.

In yet another preferable example of the hydraulic actuator of the present disclosure, the non-polar rubber layer contains at least one selected from the group consisting of butadiene rubber, natural rubber, synthetic isoprene rubber, styrene-butadiene rubber, and butyl rubber. In this case, strength of the non-polar rubber layer enhances, whereby durability of the tube further improves.

In yet another preferable example of the hydraulic actuator of the present disclosure, the polar rubber layer and the non-polar rubber layer contain carbon black. In this case, strength of the polar rubber layer and the non-polar rubber layer enhances, whereby durability of the tube further improves.

In this respect, it is preferable that the carbon black contained in the non-polar rubber layer has the nitrogen adsorption specific surface area in the range of 34 m²/g to 155 m²/g. In this case, strength of the non-polar rubber layer further enhances, whereby durability of the tube further improves.

In the present disclosure, the nitrogen adsorption specific surface area (N₂SA) of the carbon black is measured according to JIS K6217-2: 2001.

In yet another preferable example of the hydraulic actuator of the present disclosure, the non-polar rubber layer further contains silica. In this case, strength of the non-polar rubber layer further enhances, whereby durability of the tube further improves.

In this respect, it is preferable that the non-polar rubber layer further contains a silane coupling agent. In this case, strength of the non-polar rubber layer further enhances, whereby durability of the tube further improves.

In yet another preferable example of the hydraulic actuator of the present disclosure, the polar rubber layer further contains silica by 5 to 20 parts by mass with respect to 100 parts by mass of the rubber component(s) in the polar rubber layer. In this case, crack propagation resistance of the tube enhances, whereby durability of the actuator further improves.

In this respect, it is preferable that the polar rubber layer contains a silane coupling agent by 0.1 parts by mass or less with respect to 100 parts by mass of the silica. In this case, crack propagation resistance of the tube further enhances.

In yet another preferable example of the hydraulic actuator of the present disclosure, the total thickness of the polar rubber layer is 10% to 90% of the total thickness of the tube and the total thickness of the non-polar rubber layer is 90% to 10% of the total thickness of the tube. In this case, durability of the tube further improves.

In the hydraulic actuator of the present disclosure, the non-polar rubber layer has tensile stress at 100% elongation (M100) equal to or higher than 1.0 MPa. In this case, durability of the tube can be further improved.

In the present disclosure, tensile stress at 100% elongation (M100) is a value measured according to JIS K 6251.

### Advantageous Effect

According to the present disclosure, it is possible to provide a hydraulic actuator having a tube which exhibits improved durability.

### BRIEF DESCRIPTION OF THE DRAWINGS

In the accompanying drawings, wherein:

FIG. 1 is a side view of an embodiment of a hydraulic actuator 10.

FIG. 2 is a partially exploded perspective view of an embodiment of the hydraulic actuator 10.

FIG. 3 is a partial sectional view of an embodiment of a tube 110.

FIG. 4 is a partial sectional view of another embodiment of the tube 110.

FIG. 5 is a partial sectional view of the hydraulic actuator 10 including a sealing mechanism 200, cut along the axis direction D_{AX} of the hydraulic actuator, according to Embodiment 1-1.

FIG. 6 is a partial sectional view of the hydraulic actuator 10 including a sealing mechanism 200, cut along the axis direction D_{AX} of the hydraulic actuator, according to Embodiment 1-2.

FIG. 7 is a partial sectional view of the hydraulic actuator 10 including a sealing mechanism 200, cut along the axis direction D_{AX} of the hydraulic actuator, according to Embodiment 1-3.

FIG. 8 is a partial sectional view of the hydraulic actuator 10 including a sealing mechanism 200A, cut along the axis direction D_{AX} of the hydraulic actuator, according to Embodiment 2-1.

FIG. 9 is a partial sectional view of the hydraulic actuator 10 including a sealing mechanism 200A, cut along the axis direction D_{AX} of the hydraulic actuator, according to Embodiment 2-2.

FIG. 10 is a partial sectional view of the hydraulic actuator 10 including a sealing mechanism 200A, cut along the axis direction D_{AX} of the hydraulic actuator, according to Embodiment 2-3.

FIG. 11 is a partial sectional view of the hydraulic actuator 10 including a sealing mechanism 200B, cut along the axis direction D_{AX} of the hydraulic actuator, according to Embodiment 3-1.

FIG. 12 is a partial sectional view of the hydraulic actuator 10 including a sealing mechanism 200C, cut along the axis direction D_{AX} of the hydraulic actuator, according to Embodiment 3-2.

### DETAILED DESCRIPTION

Hereinafter, the hydraulic actuator of the present disclosure will be demonstratively described in detail based on embodiments thereof and with reference to the drawings. The same functions and structures share the same/similar reference numerals and repetitive or redundant explanations thereof will be omitted.

(1) Outline of Entire Structure of Hydraulic Actuator

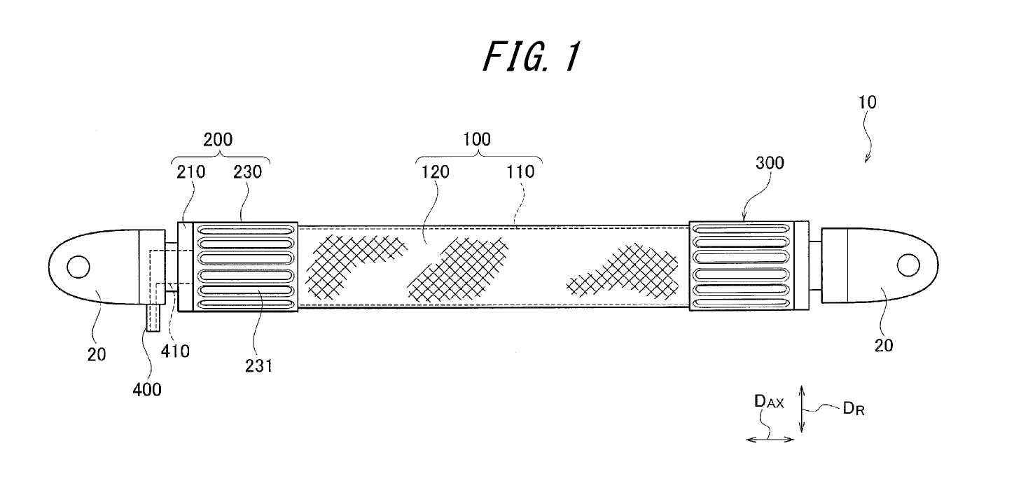

FIG. 1 is a side view of a hydraulic actuator 10 according to an embodiment of the present disclosure. As shown in FIG. 1, the hydraulic actuator 10 has an actuator main body 100, a sealing mechanism 200, and another sealing mechanism 300. Respective connection portions 20 are provided at respective ends of the hydraulic actuator 10.

The actuator main body 100 is constituted of a tube 110 and a sleeve 120. A working fluid flows into the actuator main body 100 via a fitting 400 and a passage hole 410. The actuator of the present disclosure is hydraulically operated and uses a liquid as the working fluid. Examples of the liquid include oil, water, and the like. The actuator of the present disclosure may employ either oil pressure or water pressure. The actuator of the present disclosure, of which tube 110 has high oil resistance, can be suitable used for an oil pressure system. In a case where the hydraulic actuator employs oil pressure, any suitable hydraulic oil which is conventionally used in a hydraulic driving system employing oil pressure may be used as hydraulic oil.

The actuator main body 100, when the working fluid flows into the tube 110, contracts in the axis direction D_{AX} and expands in the radial direction D_{R} of the actuator main body 100. On the other hand, the actuator main body 100, when the working fluid flows out of the tube 110, expands in the axis direction D_{AX} and contracts in the radial direction D_{R} of the actuator main body 100. The hydraulic actuator 10 functions as an actuator by such changes in configuration of the actuator main body 100 as described above.

Further, the hydraulic actuator 10 as described above is what is called a McKibben type actuator, which is applicable to artificial muscles of course and can also be suitably used for limbs (upper limbs and lower limbs) of a robot, which limbs require higher capacity (contraction force) than artificial muscles. The connection portions 20 are connected to members constituting the limbs, or the like.

The sealing mechanism 200 and the sealing mechanism 300 seal end portions of the actuator main body 100 in the axis direction D_{AX} thereof, respectively. Specifically, the sealing mechanism 200 includes a sealing member 210 and a caulking member 230. The sealing member 210 seals an end portion in the axis direction D_{AX} of the actuator main body 100. The caulking member 230 caulks the actuator main body 100 in collaboration with the sealing member 210. Indentations 231 as marks made by the caulking jigs are formed at an outer peripheral surface of the caulking member 230.

Differences between the sealing mechanism 200 and the sealing mechanism 300 reside in whether the fitting 400 (and the passage hole 410) is provided or not.

The fitting 400 protrudes such that the fitting 400 can be mounted to a driving pressure source of the hydraulic actuator 10, or more specifically a hose (a piping path) connected to a compressor of the working fluid. The working fluid which has flowed into the actuator via the fitting 400 then flows into the inside of the actuator main body 100, or more specifically the inside of the tube 110, via the passage hole 410.

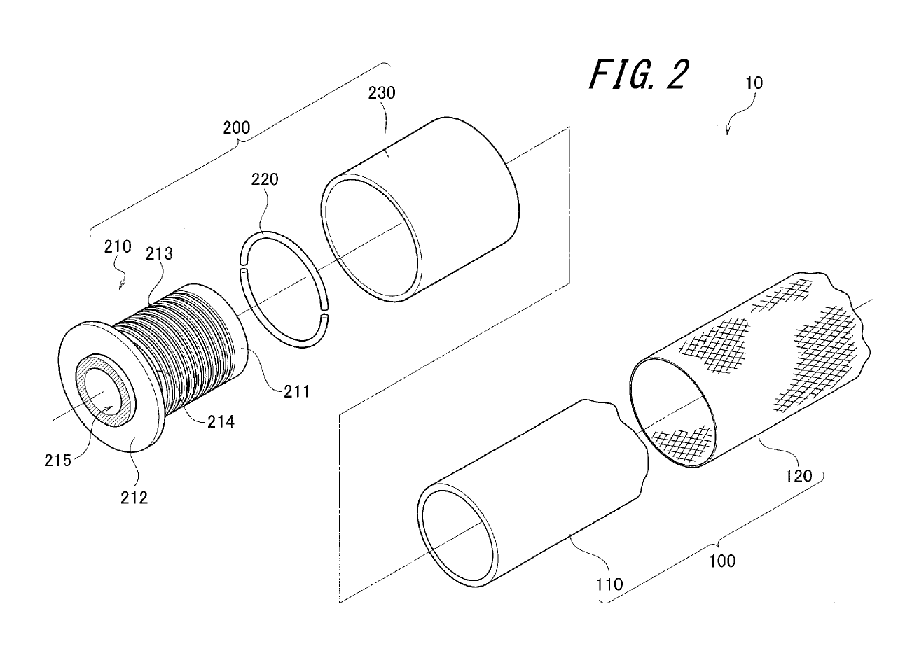

FIG. 2 is a partially exploded perspective view of the hydraulic actuator 10. As shown in FIG. 2, the hydraulic actuator 10 has the actuator main body 100 and the sealing mechanism 200.

The actuator main body 100 is constituted of the tube 110 and the sleeve 120, as described above.

The tube 110 is a cylindrical, pipe-like member capable of expanding/contracting by hydraulic pressure. The tube 110, which is to repeat contracting and expanding movements alternately by the working fluid, is made of an elastic material. In the present disclosure, the tube 110 has a laminated structure including two or more rubber layers constituted of at least one polar rubber layer and at least one non-polar rubber layer. The polar rubber layer contains, with respect to a rubber component(s) thereof, ≥50 mass % of a polar rubber of which SP value is ≥8.7 and the non-polar rubber layer contains, with respect to a rubber component(s) thereof, <50 mass % of a polar rubber of which SP value is ≥8.7.

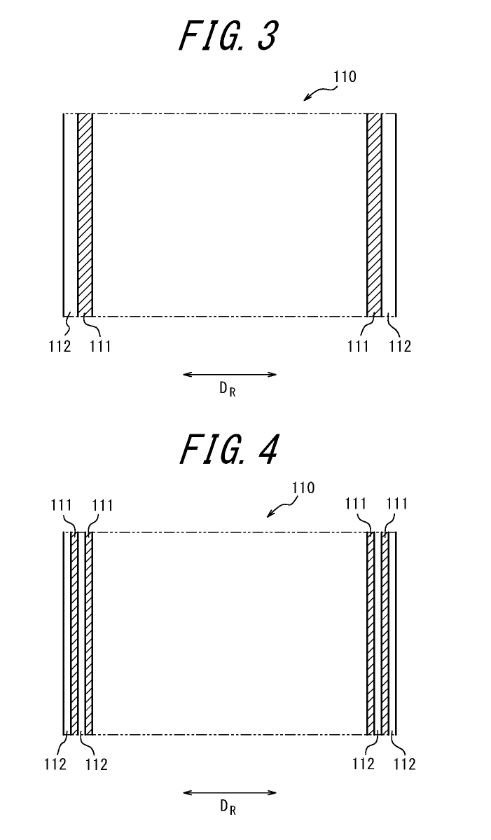

FIG. 3 is a partial sectional view of an embodiment of a tube 110. FIG. 4 is a partial sectional view of another embodiment of the tube 110.

The tube 110 shown in FIG. 3 has a two-layered structure including: a polar rubber layer 111 provided on the inner surface side of the tube; and a non-polar rubber layer 112 provided on the outer surface side of the tube 110 to be adjacent to the polar rubber layer 111 on the outer side in the radial direction D_{R} of the polar rubber layer 111.

The polar rubber layer 111 contains, with respect to a rubber component(s) thereof, 50 mass % or more of a polar rubber of which SP value is 8.7 or more. The polar rubber layer 111 is therefore excellent in liquid resistance, in particular, oil resistance, thereby exhibiting high durability when a working fluid is oil, for example.

On the other hand, the non-polar rubber layer 112 contains, with respect to a rubber component(s) thereof, less than 50 mass % of a polar rubber of which SP value is 8.7 or more. The non-polar rubber layer 112 is therefore excellent in crack resistance, wear resistance and slidability and capable of bearing load applied from the sleeve 120 side, thereby exhibiting high durability when the non-polar rubber layer 112 is in contact with the sleeve 120.

That is, the tube 110 having a laminated structure including two or more rubber layers constituted of the polar rubber layer 111 and the non-polar rubber layer 112 makes it possible to realize a hydraulic actuator having both high liquid resistance and high durability even after experiencing repeated expanding and contracting motions.

In the present disclosure, it is preferable that the polar rubber layer 111 is provided on the innermost side of the tube 110. In a case where the polar rubber layer 111 is provided on the innermost side of the tube 110, oil resistance of the tube improves, whereby durability of the tube 110 further improves.

Further, in the present disclosure, it is preferable that the non-polar rubber layer 112 is provided on the outer side in the radial direction D_{R} of the polar rubber layer 111 and on the outermost side of the tube 110. In a case where the non-polar rubber layer 112 is provided on the outer side in the radial direction D_{R} of the polar rubber layer 111, the non-polar rubber layer 112 having excellent crack resistance, wear resistance and slidability bears load applied from the sleeve 120 side and protects the polar rubber layer 111, whereby strength of the entire portion of the tube 110 enhances and thus durability of the tube 110 further improves.

In the present disclosure, the tube 110 has a laminated structure including two or more rubber layers constituted of the polar rubber layer and the non-polar rubber layer, as described above. It means that the tube 110 may have a laminated structure including, for example, three or more rubber layers as shown in FIG. 4 (a four-layered structure in FIG. 4).

In this respect, in a case where the tube 110 has a laminated structure including three or more rubber layers, it is preferable that the polar rubber layer 111 is provided on the innermost side of the tube 110 and the non-polar rubber layer 112 is provided on the outermost side of the tube 110. The polar rubber layer 111, provided on the innermost side of the tube 110 to be in direct contact with the working fluid, can most effectively exhibit high liquid resistance thereof. The non-polar rubber layer 112, provided on the outermost side of the tube 110 to be in direct contact with the sleeve 120, can most effectively exhibit high crack resistance, wear resistance and slidability thereof.

Although the tube 110 shown in FIG. 3 and FIG. 4 is constituted of only the polar rubber layer 111 and the non-polar rubber layer 112, it is acceptable in the present disclosure to provide an adhesive layer between the polar rubber layer and the non-polar rubber layer so that adhesion between the polar rubber layer and the non-polar rubber layer improves. An adequate adhesive, selected in accordance with the characteristics of the polar rubber layer and the non-polar rubber layer, may be used for the adhesive layer. For example, “Metalock R-17” manufactured by TOYO KAGAKU KENKYUSHO CO., LTD. or the like can be suitably used.

Further, in the present disclosure, the total thickness of the polar rubber layer 111 is preferably 10% to 90%, more preferably 20% to 80%, of the total thickness of the tube 110 and the total thickness of the non-polar rubber layer 112 is preferably 90% to 10%, more preferably 80% to 20%, of the total thickness of the tube 110. In this case, liquid resistance and durability of the tube 110 improves, thereby further improving durability of the actuator.

The total thickness of the tube 110, which may be appropriately set in accordance with an intended application, is preferably in the range of 1.0 mm to 6.0 mm in terms of durability and a maneuverable length of the actuator. The diameter (outer diameter) of the tube 110 may be appropriately set in accordance with an intended application.

The sleeve 120 has a cylindrical configuration and covers an outer peripheral surface of the tube 110. The sleeve 120 has a woven structure formed by weaving cords to be disposed in certain directions, wherein the cords thus disposed intersect each other in a woven manner to provide rhombus configurations in a repetitive and continuous manner. The sleeve 120 having such a configuration as described above can deform like a pantograph and follow contraction/expansion of the tube 110, while also regulating the contraction/expansion.

It is preferable to use, as the cord 121 of the sleeve 120, a fiber cord made of at least one fiber material selected from the group consisting of: polyimide fibers such as aramid fiber (aromatic polyamide fiber), polyhexamethylene adipamide (Nylon 6,6) fiber, polycaprolactam (Nylon 6) fiber and the like; polyester fiber such as polyethylene terephthalate (PET) fiber, polyethylene naphthalate (PEN) fiber and the like; polyurethane fiber; rayon; acrylic fiber; and polyolefin fiber. It is particularly preferable to use a cord made of aramid fiber in terms of ensuring satisfactory strength of the sleeve 120.

However, the cord 121 is not restricted to such fiber cords as described above. It is acceptable, for example, to use as the cord 121 a cord made of high strength fiber such as PBO (poly para-phenylene benzobisoxazole) fiber or a metal cord made of ultra-fine filaments.

Surfaces of the fiber/metal cords described above may be covered with rubber, mixture of a thermosetting resin and latex, or the like. In a case where surfaces of the cords are covered with these materials, it is possible to decrease a friction coefficient of the surfaces of the cords to an adequate level, while improving durability of the cords.

A solid content, in the mixture, of a thermosetting resin and latex is preferably in the range of ≥15 mass % and ≤50 mass % and more preferably in the range of ≥20 mass % and ≤40 mass %. Examples of the thermosetting resin include phenol resin, resorcin resin, urethane resin, and the like. Examples of the latex include vinyl pyridine (VP) latex, styrene-butadiene rubber (SBR) latex, acrylonitrile-butadiene rubber (NBR) latex, and the like.

The sleeve may have either a single-layer structure or a multi-layered structure. In a case of a multi-layered structure, the sleeve may be formed by either sequentially laminating a plurality of layers so that the sleeve has a concentric multi-ring-like section or winding a sheet a plural times so that the sleeve has a scroll-like section.

In FIG. 2, the sealing mechanism 200 seals an end portion in the axis direction D_{AX} of the actuator main body 100. The sealing mechanism 200 includes the sealing member 210, a first locking ring 220 and the caulking member 230.

The sealing member 210 has a trunk portion 211 and a flange portion 212. Metal such as stainless steel can be suitably used for the sealing member 210. However, the material for the sealing member 210 is not restricted to metal and a hard plastic material or the like can be used instead of metal.

The trunk portion 211 has a tube-like shape. A passage hole 215 through which the working fluid flows is formed in the trunk portion 211. The passage hole 215 communicates with the passage hole 410 (see FIG. 1). The trunk portion 211 is inserted into the tube 110.

The flange portion 212, which is integral with the trunk portion 211, is positioned further on the side of the axis direction D_{AX} end portion of the hydraulic actuator 10 than the trunk portion 211. The flange portion 212 has a larger outer diameter in the radial direction D_{R} than the outer diameter of the trunk portion 211. The flange portion 212 is fixedly engaged with the tube 110 having the trunk portion 211 inserted therein and the first locking ring 220.

Irregular portions 213 are formed at an outer peripheral surface of the trunk portion 211. The irregular portions 213 contribute to suppressing slippage of the tube 110 relative to the trunk portion 211 inserted therein. The irregular portions 213 preferably include at least three projecting portions.

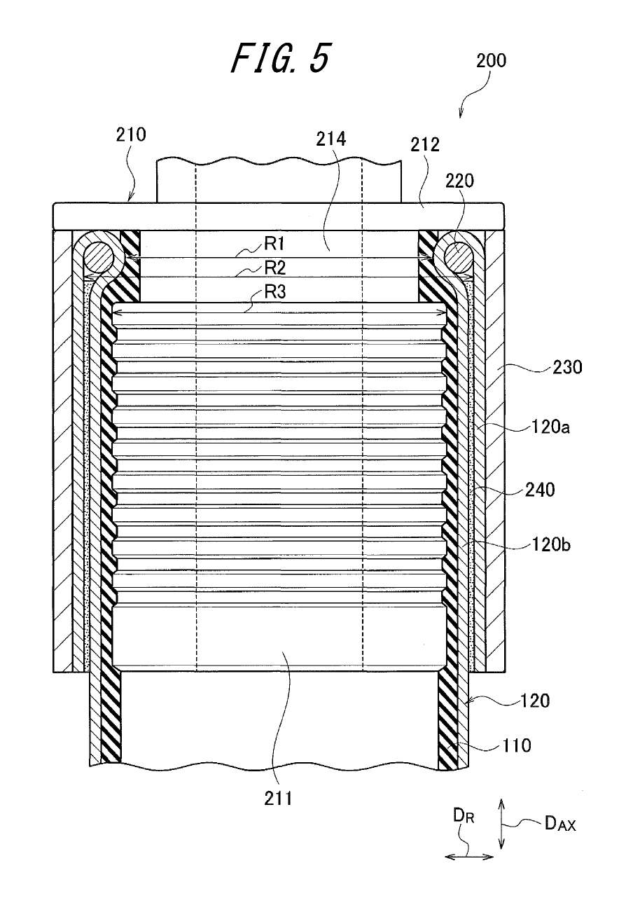

Further, a first small diameter portion 214, of which outer diameter is smaller than that of the trunk portion 211, is formed in a portion adjacent to the flange portion 212, of the trunk portion 211. The configuration of the first small diameter portion 214 will be further described with reference to FIGS. 5 to 12.

The first locking ring 220 is fixedly engaged with the sleeve 120. Specifically, the sleeve 120 is folded on the outer side in the radial direction D_{R} and backward by way of the first locking ring 220 (not shown in FIG. 2. See FIG. 5).

The outer diameter of the first locking ring 220 is larger than that of the trunk portion 211. The first locking ring 220 is fixedly engaged with the sleeve 120 at the position of the first small diameter portion 214 of the trunk portion 211. That is, the first locking ring 220 is fixedly engaged with the sleeve 120 at a position adjacent to the flange portion 212 and on the radial direction D_{R} outer side of the trunk portion 211.

The first locking ring 220 has a configuration split into two portions in the embodiments, so that the first locking ring 220 can be engaged with the first small diameter portion 214 having an outer diameter smaller than that of the trunk portion 211. It should be noted that the configuration of the first locking ring 220 is not restricted to the aforementioned two-split one. The first locking ring 220 may be split into three or more portions and some of the split portions may be pivotably linked with each other.

Any of metal, a hard plastic material or the like, i.e. those similar to the materials for the sealing member 210, can be used as a material for the first locking ring 220.

The caulking member 230 caulks the actuator main body 100 in collaboration with the sealing member 210. Metal such as aluminum alloy, brass, iron or the like can be used as a material for the caulking member 230. Indentations 231 as shown in FIG. 1 are formed at an outer surface of the caulking member 230 as a result of the caulking member's being caulked by the caulking jigs.

(2) Structure of Sealing Mechanism

Next, embodiments of the sealing mechanism 200 will be described with reference to FIGS. 5 to 12.

### (2.1) Embodiment 1-1

FIG. 5 is a partial sectional view of the hydraulic actuator 10 including a sealing mechanism 200, cut along the axis direction D_{AX} of the hydraulic actuator, according to Embodiment 1-1.

The sealing member 210 has the first small diameter portion 214, of which outer diameter is smaller than that of the trunk portion 211, as described above.

The first locking ring 220 is disposed on the outer side in the radial direction D_{R} of the first small diameter portion 214. The inner diameter R1 of the first locking ring 220 is smaller than the outer diameter R3 of the trunk portion 211. The outer diameter R2 of the first locking ring 220 may also be smaller than the outer diameter R3 of the trunk portion 211.

The tube 110 has a laminated structure including two or more rubber layers constituted of a polar rubber layer and a non-polar rubber layer (not shown). The trunk portion 211 is inserted into the tube 110 such that the tube 110 is in contact with the flange portion 212. The sleeve 120, on the other hand, is folded on the outer side in the radial direction D_{R} and then backward via the first locking ring 220. As a result, the sleeve 120 has a first folded-back portion 120a, which has been folded backward by way of the first locking ring 220 at the end in the axis direction D_{AX} of the actuator. Specifically, the sleeve 120 includes: a sleeve main body 120b covering the outer peripheral surface of the tube 110 and the first folded-back portion 120a folded backward at the end in the axis direction D_{AX} of the sleeve main body 120b to be disposed on the outer peripheral side of the sleeve main body 120b.

The first folded-back portion 120a is attached to the sleeve main body 120b situated on the outer side in the radial direction D_{R} of the tube 110. Specifically, an adhesive layer 240 is formed between the sleeve main body 120b and the first folded-back portion 120a, so that the sleeve main body 120b and the first folded-back portion 120a are fixedly attached to each other by the adhesive layer 240. An appropriate adhesive can be used for the adhesive layer 240 in accordance with the type of the cords constituting the sleeve 120.

However, the adhesive layer 240 is not essentially needed in the present disclosure and it is acceptable that the first folded-back portion 120a is not fixedly attached to the sleeve main body 120b.

The trunk portion 211 of the sealing member 210 is inserted into the caulking member 230 having an inner diameter larger than the outer diameter of the trunk portion 211 and then the caulking member is caulked by the jig members. The caulking member 230 caulks the actuator main body 100 in collaboration with the sealing member 210. Specifically, the caulking member 230 caulks the tube 110 having the trunk portion 211 inserted therein, the sleeve main body 120b, and the first folded-back portion 120a. That is, the caulking member 230 caulks the tube 110, the sleeve main body 120b, and the first folded-back portion 120a in collaboration with the sealing member 210.

### (2.2) Embodiment 1-2

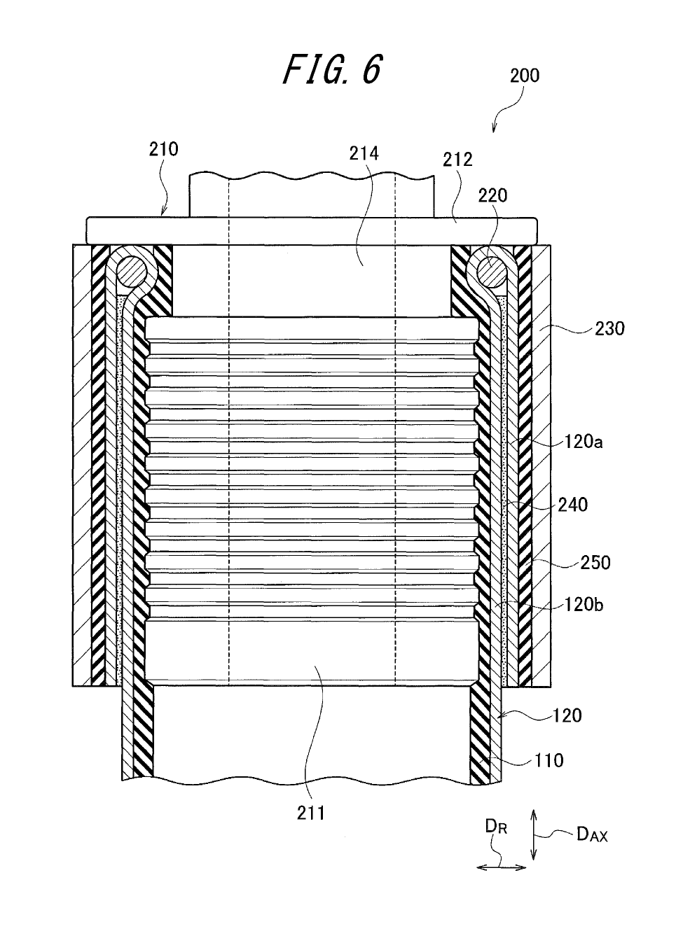

FIG. 6 is a partial sectional view of the hydraulic actuator 10 including a sealing mechanism 200, cut along the axis direction D_{AX} of the hydraulic actuator, according to Embodiment 1-2. Hereinafter, Embodiment 1-2 will be described mainly in regard to differences between Embodiment 1-1 and itself.

In Embodiment 1-2, a sheet-like elastic member is provided between the first folded-back portion 120a of the sleeve 120 and the caulking member 230. Specifically, a rubber sheet 250 is provided between the first folded-back portion 120a and the caulking member 230. The rubber sheet 250 is provided so as to cover an outer peripheral surface of the cylindrical first folded-back portion 120a. The type of rubber sheet 250 is not particularly restricted. A rubber material similar to the rubber of the tube 110 may be used for the rubber sheet 250. The caulking member 230 caulks the actuator main body 100 including the rubber sheet 250 in collaboration with the sealing member 210.

### (2.3) Embodiment 1-3

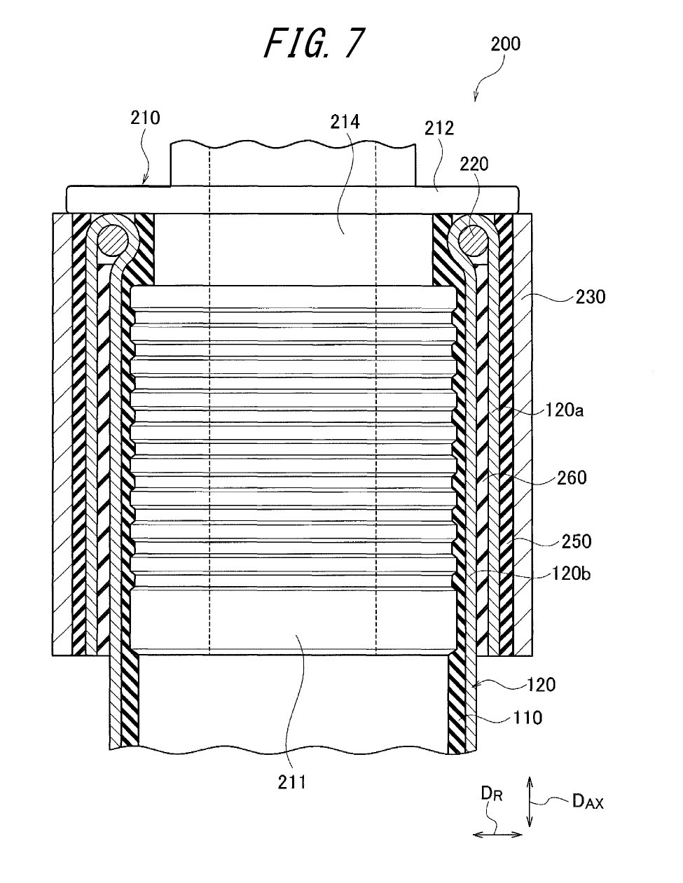

FIG. 7 is a partial sectional view of the hydraulic actuator 10 including a sealing mechanism 200, cut along the axis direction D_{AX} of the hydraulic actuator, according to Embodiment 1-3.

In Embodiment 1-3, a rubber sheet 260 is used in place of the adhesive layer 240 of Embodiment 1-1. The rubber sheet 260 is a sheet-like elastic member and provided between the sleeve main body 120b and the first folded-back portion 120a. A rubber material similar to the rubber of the rubber sheet 250 may be used for the rubber sheet 260.

### (2.4) Embodiment 2-1

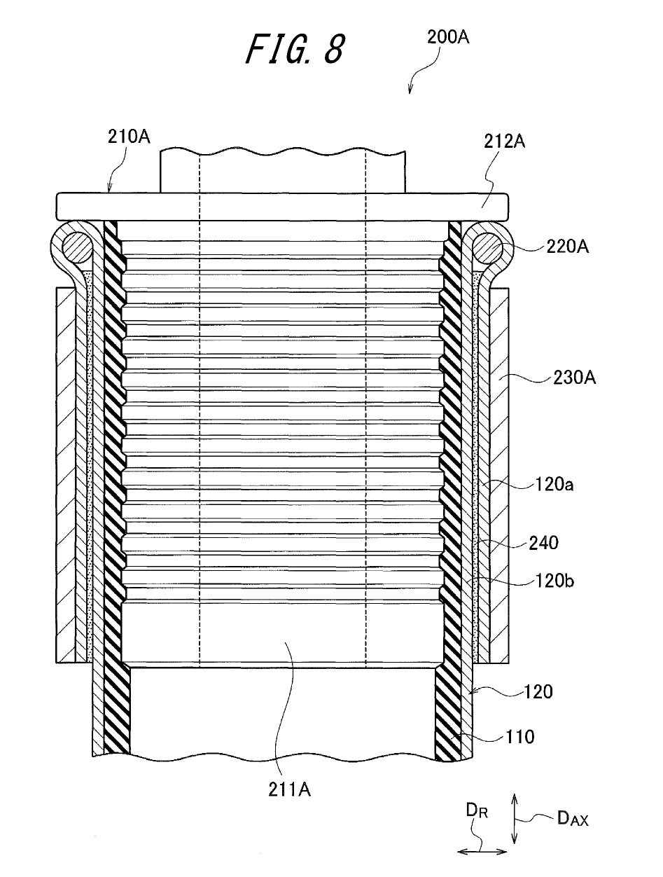

FIG. 8 is a partial sectional view of the hydraulic actuator 10 including a sealing mechanism 200A, cut along the axis direction D_{AX} of the hydraulic actuator, according to Embodiment 2-1.

In Embodiment 2-1, a sealing mechanism 200A is used in place of the sealing mechanism 200 of Embodiments 1-1, 1-2 and 1-3. The sealing mechanism 200A differs from the sealing mechanism 200 in that the former lacks the first small diameter portion 214 formed in the latter.

The sealing mechanism 200A includes a sealing member 210A, a first locking ring 220A, and a caulking member 230A.

A trunk portion 211A of the sealing member 210A is inserted into the tube 110 having a laminated structure including two or more rubber layers constituted of a polar rubber layer and a non-polar rubber layer (not shown). Since the sealing member 210A lacks the first small diameter portion 214 provided in the sealing member 210, the diameter of the first locking ring 220A is larger than the outer diameter of the entire trunk portion 211A. Accordingly, the first locking ring 220A is held by the flange portion 212A and the caulking member 230A between the flange portion 212A and the caulking member 230A.

Since the diameter of the first locking ring 220A is larger than the outer diameter of the entire trunk portion 211A, the caulking member 230A is not in contact with the flange portion 212A. That is, the first locking ring 220A is exposed to the exterior at the portion thereof on which the sleeve 120 is folded backward. Further, the first locking ring 220A need not be split like the first locking ring 220 of the embodiments 1-1, 1-2 and 1-3 because the diameter of the first locking ring 220A is safely larger than the outer diameter of the entire trunk portion 211A.

An adhesive layer 240 is formed between the sleeve main body 120b and the first folded-back portion 120a in the present embodiment, as in Embodiment 1-1.

### (2.5) Embodiment 2-2

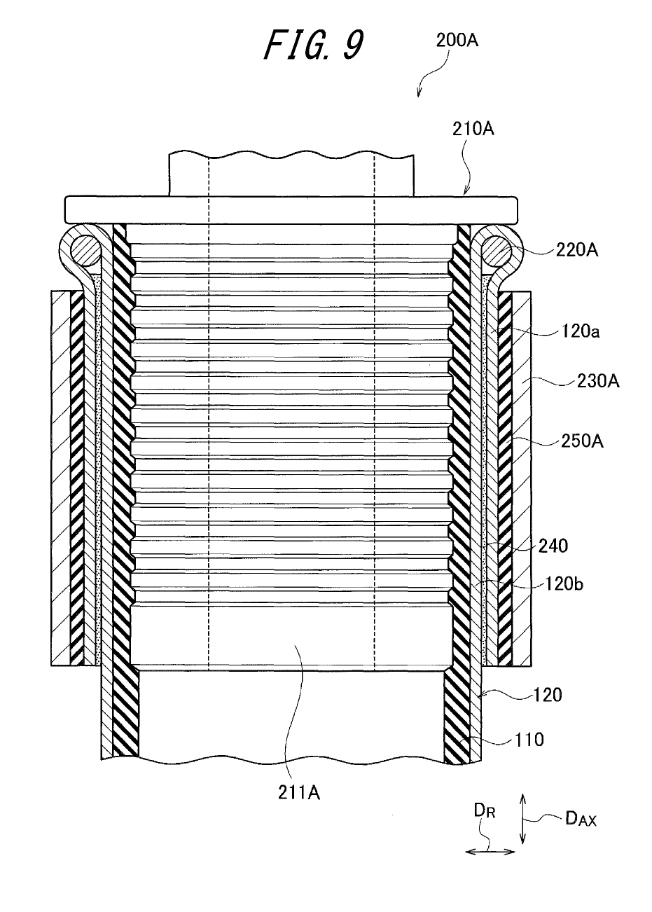

FIG. 9 is a partial sectional view of the hydraulic actuator 10 including a sealing mechanism 200A, cut along the axis direction D_{AX} of the hydraulic actuator, according to Embodiment 2-2. Hereinafter, Embodiment 2-2 will be described mainly in regard to differences between Embodiment 2-1 and itself.

In Embodiment 2-2, a sheet-like elastic member is provided between the first folded-back portion 120a of the sleeve 120 and the caulking member 230A. Specifically, a rubber sheet 250A is provided between the first folded-back portion 120a and the caulking member 230A. The rubber sheet 250A is provided so as to cover an outer peripheral surface of the cylindrical first folded-back portion 120a as the rubber sheet 250 does in Embodiment 1-2.

### (2.6) Embodiment 2-3

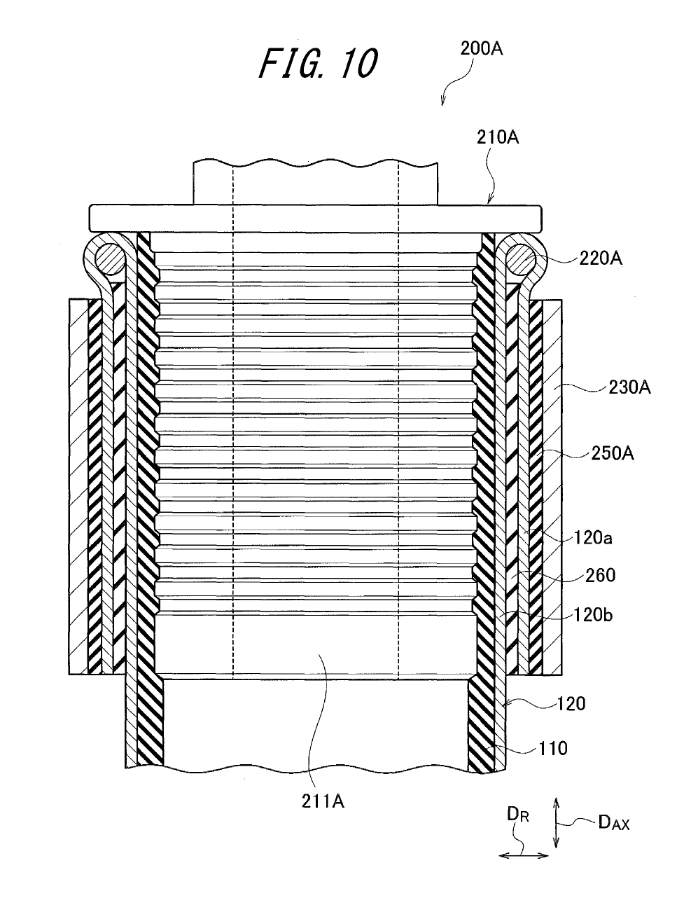

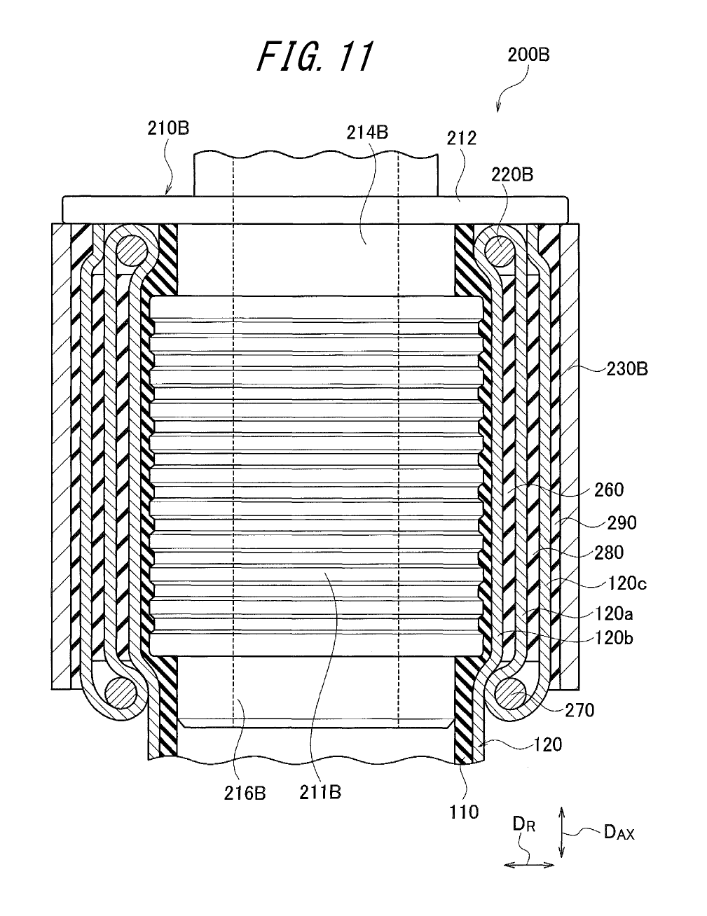

FIG. 10 is a partial sectional view of the hydraulic actuator 10 including a sealing mechanism 200A, cut along the axis direction D_{AX} of the hydraulic actuator, according to Embodiment 2-3.

In Embodiment 2-3, a rubber sheet 260 is used in place of the adhesive layer 240 of Embodiment 2-1. The rubber sheet 260 is a sheet-like elastic member and provided between the sleeve main body 120b and the first folded-back portion 120a, as in Embodiment 1-3.

### (2.7) Embodiment 3-1

FIG. 11 is a partial sectional view of the hydraulic actuator 10 including a sealing mechanism 200B, cut along the axis direction D_{AX} of the hydraulic actuator, according to Embodiment 3-1. Embodiment 3-1 and Embodiment 3-2 employ two locking rings.

The sealing mechanism 200B includes a sealing member 210B, a first locking ring 220B, a caulking member 230B, and a second locking ring 270, as shown in FIG. 11.

The sealing mechanism 200B includes the second locking ring 270, as well as the first locking ring 220B, as described above. The second locking ring 270 fixedly holds the sleeve 120 at a position on the outer side in the radial direction D_{R} of a trunk portion 211B and closer to the center in the axis direction D_{AX} of the actuator main body 100 than the first locking ring 220B.

Specifically, the sealing member 210B has a second small diameter portion 216B, of which outer diameter is smaller than that of the trunk portion 211B.

The second locking ring 270 is provided on the outer side in the radial direction D_{R} of the second small diameter portion 216B. The inner diameter of the second locking ring 270 is preferably smaller than the outer diameter of the trunk portion 211B. The outer diameter of the second locking ring 270 may also be smaller than the outer diameter of the trunk portion 211B. Due to this structure, the second locking ring 270 is fixedly engaged with the second small diameter portion 216B.

The sleeve 120 has a second folded-back portion 120c, which has been folded forward by way of the second locking ring 270. The second folded-back portion 120c is continuous with the first folded-back portion 120a. Specifically, the second folded-back portion 120c is folded forward at an end in the axis direction D_{AX} of the first folded-back portion 120a to be disposed on the outer peripheral side of the first folded-back portion 120a.

More specifically, the sleeve 120, folded toward the center side in the axis direction D_{AX} of the actuator main body 100 by way of the first locking ring 220B, forms the first folded-back portion 120a. The first folded-back portion 120a of the sleeve 120 is then folded on the side of the end portion in the axis direction D_{AX} of the actuator main body 100, thereby forming the second folded-back portion 120c.

The caulking member 230B caulks the tube 110 having the trunk portion 211B inserted therein, the sleeve main body 120b situated on the outer side in the radial direction D_{R} of the tube 110, the first folded-back portion 120a, and the second folded-back portion 120c in collaboration with the sealing member 210B.

The rubber sheet 260 is provided between the sleeve main body 120b and the first folded-back portion 120a, as in Embodiment 1-3.

Further, a sheet-like elastic member is provided between the first folded-back portion 120a and the second folded-back portion 120c, as well. Specifically, a rubber sheet 280 is provided between the first folded-back portion 120a and the second folded-back portion 120c. The rubber sheet 280 is provided so as to cover an outer peripheral surface of the cylindrical first folded-back portion 120a.

Yet further, a rubber sheet 290 having a configuration similar to that of the rubber sheet 250 of Embodiment 1-3 is provided between the second folded-back portion 120c and the caulking member 230B. The rubber sheet 290 is provided so as to cover an outer peripheral surface of the cylindrical second folded-back portion 120c.

### (2.8) Embodiment 3-2

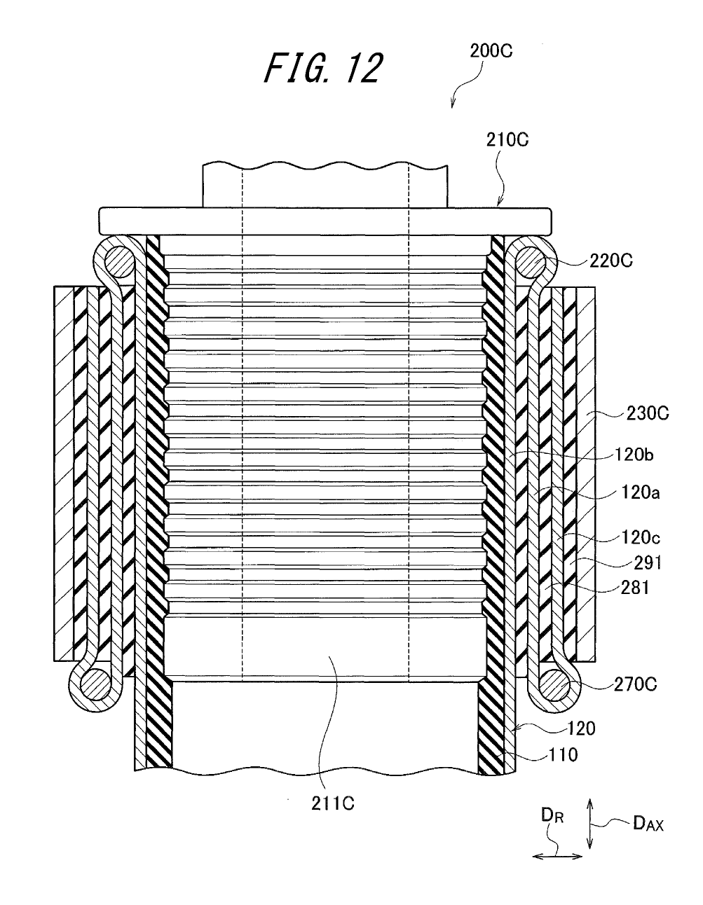

FIG. 12 is a partial sectional view of the hydraulic actuator 10 including a sealing mechanism 200C, cut along the axis direction D_{AX} of the hydraulic actuator, according to Embodiment 3-2. Hereinafter, Embodiment 3-2 will be described mainly in regard to differences between Embodiment 3-1 and itself.

Embodiment 3-2 employs a sealing member 210C in which neither the first small diameter portion 214B nor the second small diameter portion 216B is formed.

The sealing member 210C has a trunk portion 211C. Since neither the first small diameter portion 214B nor the second small diameter portion 216B of the sealing member 210B is formed in the sealing member 210C, the inner diameter of the first locking ring 220C and the inner diameter of the second locking ring 270C are larger than the outer diameter of the trunk portion 211C, respectively.

The caulking member 230C is positioned between the first locking ring 220C and the second locking ring 270C in the axis direction D_{AX}. Accordingly, the first locking ring 220C and the second locking ring 270C are exposed to the exterior at the portions thereof on which the sleeve 120 is folded backward/forward.

Further, a rubber sheet 281 having a configuration similar to that of the rubber sheet 280 of Embodiment 3-1 is provided between the first folded-back portion 120a and the second folded-back portion 120c. Yet further, a rubber sheet 291 having a configuration similar to that of the rubber sheet 290 of Embodiment 3-1 is provided between the second folded-back portion 120c of the sleeve 120 and the caulking member 230C.

(3) Material of Tube 110

The tube 110 has a laminated structure including two or more rubber layers, the rubber layers being constituted of at least one polar rubber layer 111 containing, with respect to a rubber component(s) thereof, ≥50 mass % of a polar rubber of which SP value is ≥8.7 and at least one non-polar rubber layer 112 containing, with respect to a rubber component(s) thereof, <50 mass % of a polar rubber of which SP value is ≥8.7.

Type of the polar rubber having SP value equal to or higher than 8.7 is not particularly restricted and examples of the polar rubber include acrylonitrile-butadiene rubber (NBR, which may occasionally be referred to as “nitrile rubber” hereinafter), hydrogenated acrylonitrile-butadiene rubber (hydrogenated NBR, which may occasionally be referred to as “hydrogenated nitrile rubber” hereinafter), chloroprene rubber (CR), epichlorohydrin rubber, and the like. These polar rubbers can be used by either a single type or two or more types in combination.

The polar rubber layer 111 preferably contains acrylonitrile-butadiene rubber and/or hydrogenated acrylonitrile-butadiene rubber. Acrylonitrile-butadiene rubber and hydrogenated acrylonitrile-butadiene rubber exhibit particularly high oil resistance, as well as good workability, among the polar rubbers described above. Accordingly, in a case where the polar rubber layer 111 contains acrylonitrile-butadiene rubber and/or hydrogenated acrylonitrile-butadiene rubber, oil resistance of the polar rubber layer 111 further improves. Further, it is preferable that the acrylonitrile-butadiene rubber and the hydrogenated acrylonitrile-butadiene rubber contain acrylonitrile units therein by 20 mass % to 50 mass %, respectively, because then oil resistance of the polar rubber layer 111 further improves. Acrylonitrile-butadiene rubber and/or hydrogenated acrylonitrile-butadiene rubber is generally classified into the low nitrite content type having content of acrylonitrile units less than 25 mass %, the intermediate nitrile content type having content of acrylonitrile units of ≥25 mass % and <35 mass % and the high nitrile content type having content of acrylonitrile units equal to or higher than 35 mass %.

It is preferable that the acrylonitrile-butadiene rubber and/or the hydrogenated acrylonitrile-butadiene rubber include at least two types of acrylonitrile-butadiene rubber and/or hydrogenated acrylonitrile-butadiene rubber having different contents of acrylonitrile units. A desired nitrile content can be easily achieved by using at least two types of acrylonitrile-butadiene rubber and/or hydrogenated acrylonitrile-butadiene rubber.

The content of acrylonitrile-butadiene rubber (NBR) and hydrogenated acrylonitrile-butadiene rubber (hydrogenated NBR) in a rubber component(s) of the polar rubber layer 111 is preferably in the range of 50 mass % to 100 mass % and more preferably in the range of 60 mass % to 90 mass %.

Hydrogenated acrylonitrile-butadiene rubber is obtained by adding hydrogen to acrylonitrile-butadiene rubber. Hydrogenated acrylonitrile-butadiene rubber is preferable because it generally has oil resistance equivalent to that of acrylonitrile-butadiene rubber and exhibits better heat resistance than acrylonitrile-butadiene rubber.

Chloroprene rubber is preferable among the polar rubbers described above because it is excellent in mechanical properties such as tensile strength, elongation, as well as workability.

Epichlorohydrin rubber is preferable among the polar rubbers described above because it is excellent in ozone resistance and adhesion property.

The polar rubber layer 111 contains a polar rubber having SP value equal to or higher than 8.7 by at least 50 mass %, preferably in the range of 60 mass % to 100 mass %, and more preferably in the range of 60 mass % to 95 mass %, in the rubber component(s) thereof. Setting the content of a polar rubber in the polar rubber layer 111 to be within the aforementioned range further improves oil resistance of the polar rubber layer 111.

On the other hand, the non-polar rubber layer 112 contains a polar rubber having SP value equal to or higher than 8.7 by less than 50 mass %, preferably in the range of 0 mass % to 10 mass %, in the rubber components thereof. Setting the content of a polar rubber in the non-polar rubber layer 112 to be within the aforementioned range ensures an increase in content of a non-polar rubber having SP value less than 8.7 in the non-polar rubber layer 112.

The polar rubber layer 111 has the weighted average nitrile content in the rubber component(s) thereof preferably in the range of ≥20 mass % and ≤45 mass %. In this case, oil resistance of the polar rubber layer 111 further enhances, whereby durability of the tube further improves.

The polar rubber layer 111 and the non-polar rubber layer 112 may contain, as a rubber component thereof, a rubber other than the polar rubber having SP value equal to or higher than 8.7 described above, for example, a non-polar diene-based rubber having SP value less than 8.7.

Examples of the non-polar diene-based rubber having SP value less than 8.7, which may be contained in the polar rubber layer 111, include butadiene rubber (BR). Vinyl cis-polybutadiene rubber (VC-BR) is preferable in particular.

VC-BR is a rubber constituted of polybutadiene including cis-1,4 units as repeating units thereof and polybutadiene including 1,2-vinyl units as repeating units thereof. A proportion of the cis-1,4 units in microstructures other than 1,2-vinyl units, of VC-BR, is generally equal to or higher than 97 mass %. Mechanical strength of the polar rubber layer 111 enhances when the polar rubber layer 111 contains VC-BR.

The non-polar rubber layer 112, containing a polar rubber having SP value equal to or higher than 8.7 by less than 50 mass % in the rubber component(s) thereof as described above, naturally contains other rubber component(s). Examples of the other rubber components include butadiene rubber (BR), natural rubber (NR), synthetic isoprene rubber (IR), styrene-butadiene rubber (SBR), butyl rubber, and the like. Crack resistance, wear resistance and slidability of the non-polar rubber layer 112 improve and thus durability of the tube further improves when the non-polar rubber layer 112 contains the aforementioned other rubber component(s).

The polar rubber layer 111 and the non-polar rubber layer 112 preferably contain, in addition to the rubber components described above, at least one material selected from the group consisting of polyvinyl chloride (PVC), zinc polyacrylate, and an aliphatic resin, depending on an intended application. Mechanical strength of the tube enhances when the polar rubber layer and the non-polar rubber layer contain these materials. Examples of the aliphatic resin include a polyolefin-based resin.

The polar rubber layer 111 and the non-polar rubber layer 112 may contain, in addition to the aforementioned rubber components, yet other compounding agents. Examples of such other compounding agents include carbon black, silica, zinc white, stearic acid, anti-oxidant, plasticizer, sulfur, scorch-preventing agent, vulcanization accelerator, organic peroxide, and the like.

The polar rubber layer 111 and the non-polar rubber layer 112 preferably contain carbon black. Strength of the polar rubber layer 111 and the non-polar rubber layer 112 enhances and thus durability of the tube 110 improves when the polar rubber layer 111 and the non-polar rubber layer 112 contain carbon black. Content of carbon black is preferably in the range of 5 to 70 parts by mass, more preferably in the range of 30 to 70 parts by mass, and further more preferably in the range of 40 to 60 parts by mass, with respect to 100 parts by mass of the rubber components.

Further, content of carbon black in the polar rubber layer 111 is preferably in the range of 5 to 50 parts by mass, more preferably in the range of 5 to 45 parts by mass, and further more preferably in the range of 5 to 30 parts by mass, with respect to 100 parts by mass of the rubber component(s) in the polar rubber layer 111. Strength of the tube 110 further enhances and thus durability of the tube 110 further improves when the content of carbon black in the polar rubber layer 111 is equal to or higher than 5 parts by mass with respect to 100 parts by mass of the rubber component(s) in the polar rubber layer 111. Durability of the tube 110 further improves when the content of carbon black in the polar rubber layer 111 is equal to or lower than 50 parts by mass with respect to 100 parts by mass of the rubber component(s) in the polar rubber layer 111 because then elongation at break (Eb) of the tube 110 increases.

Content of carbon black in the non-polar rubber layer 112 is preferably in the range of 5 to 70 parts by mass, more preferably in the range of 25 to 50 parts by mass, with respect to 100 parts by mass of the rubber component(s) in the non-polar rubber layer 112.

Type of the carbon black is not particularly restricted and examples thereof include carbon black products of GPF, FEF, HAF, ISAF, SAF grades. These carbon black products can be used by either a single type or two or more types in combination.

The carbon black contained in the non-polar rubber layer 112 has the nitrogen adsorption specific surface area preferably in the range of 34 m²/g to 155 m²/g, more preferably in the range of 40 m²/g to 155 m²/g, further more preferably in the range of 70 m²/g to 145 m²/g. Setting the nitrogen adsorption specific surface area of carbon black contained in the non-polar rubber layer 112 to be within the aforementioned ranges further improves crack resistance, wear resistance and slidability of the non-polar rubber layer 112.

On the other hand, type of the carbon black contained in the polar rubber layer 111 is not particularly restricted. However, the nitrogen adsorption specific surface area of carbon black contained in the polar rubber layer 111 is preferably in the range of 70 m²/g to 145 m²/g. Setting the nitrogen adsorption specific surface area of carbon black contained in the polar rubber layer 111 to be within the aforementioned ranges further improves strength of the polar rubber layer 111.

The polar rubber layer 111 may further contain silica. Content of silica is preferably in the range of 5 to 20 parts by mass, more preferably in the range of 5 to 10 parts by mass, with respect to 100 parts by mass of the rubber component(s) in the polar rubber layer 111. Strength of the tube 110 enhances and thus crack propagation resistance of the tube 110 is made satisfactorily high when the content of silica in the polar rubber layer 111 is equal to or higher than 5 parts by mass with respect to 100 parts by mass of the rubber component(s) in the polar rubber layer 111. Further, the crack propagation resistance of the tube 110 can be further improved by setting the content of silica in the polar rubber layer 111 to be equal to or lower than 20 parts by mass with respect to 100 parts by mass of the rubber component(s) in the polar rubber layer 111.

Type of the silica is not particularly restricted and examples thereof include wet silica (hydrated silica), dry silica (anhydrous silica), calcium silicate, aluminum silicate, and the like. Wet silica is preferable among these examples. These silicas can be used by either a single type or two or more types in combination.

The polar rubber layer 111 may further contain a silane coupling agent. Content of the silane coupling agent is preferably in the range of 0.1 parts by mass or less with respect to 100 parts by mass of the silica described above. It is acceptable that the polar rubber layer does not contain a silane coupling agent. That is, content of the silane coupling agent in the polar rubber layer 111 is preferably in the range of 0 to 0.1 parts by mass with respect to 100 parts by mass of the silica. Silica and the rubber component form covalent bonds therebetween (i.e. bound rubber is formed), whereby hysteresis loss is reduced, when a silane coupling agent is added to the polar rubber layer. Since high hysteresis loss is advantageous in terms of suppressing propagation of cracks, the lower content of a silane coupling agent is the better. In this respect, the content of the silane coupling agent≤0.1 parts by mass with respect to 100 parts by mass of the silica ensures occurrence of energy loss when a rubber component is peeled off from silica surfaces upon application of stress strain, thereby further improving crack propagation resistance of the polar rubber layer 111. Accordingly, it is particularly preferable that the polar rubber layer contains no silane coupling agent.

The non-polar rubber layer 112 preferably further contains silica. Strength of the non-polar rubber layer 112 enhances and thus durability of the tube 110 improves when the non-polar rubber layer 112 contains silica. Content of silica is preferably in the range of 10 to 30 parts by mass, more preferably in the range of 15 to 25 parts by mass, with respect to 100 parts by mass of the rubber component(s) in the non-polar rubber layer 112. Type of the silica is not particularly restricted and examples thereof include wet silica (hydrated silica), dry silica (anhydrous silica), calcium silicate, aluminum silicate, and the like. Wet silica is preferable among these examples. These silicas can be used by either a single type or two or more types in combination.

in a case where the non-polar rubber layer 112 contains silica, it is preferable that the non-polar rubber layer 112 contains a silane coupling agent, as well. Strength of the non-polar rubber layer 112 enhances and thus durability of the tube 110 improves when the non-polar rubber layer 112 contains a silane coupling agent, as well as silica. Content of the silane coupling agent is preferably in the range of 1 to 15 parts by mass, more preferably in the range of 2 to 10 parts by mass, with respect to 100 parts by mass of the silica.

Type of the silence coupling agent is not particularly restricted and examples thereof include bis(3-triethoxysilylpropyl) tetrasulfide, bis(3-triethoxysilylpropyl) trisulfide, bis(3-triethoxysilylpropyl) disulfide, bis(2-triethoxysilylethyl) tetrasulfide, bis(3-trimethoxysilylpropyl) tetrasulfide, bis(2-trimethoxysilylethyl) tetrasulfide, (3-mercaptopropyl)trimethoxysilane, (3-mercaptopropyl)triethoxysilane, (2-mercaptoethyl)trimethoxysilane, (2-mercaptoethyl)triethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropylbenzothiazolyl tetrasulfide, 3-triethoxysilylpropylbenzothiazolyl tetrasulfide, 3-triethoxysilylpropyl methacrylate monosulfide, 3-trimethoxysilylpropyl methacrylate monosulfide, bis(3-diethoxymethylsilylpropyl) tetrasulfide, (3-mercaptopropyl)dimethoxymethylsilane, dimethoxymethylsilylpropyl-N,N-dimethylthiocarbamoyl tetrasulfide, dimethoxymethylsilylpropylbenzothiazolyl tetrasulfide, and the like. These silane coupling agents can be used by either a single type or two or more types in combination.

Examples of the anti-oxidant include N-phenyl-N′-(1,3-diphenylbutyl)-p-phenylenediamine, N-phenyl-N′-(1,3-dimethylbutyl)-p-phenylenediamine, and the like. Examples of the plasticizer include oil, and the like. Examples of the scorch-preventing agent include N-(cyclohexylthio)phthalimide, and the like. Examples of the vulcanization accelerator include N-cyclohexyl-2-benzothiazolylsulfenamide (CBS), 1,3-diphenylguanidine (DPG), tetrakis(2-ethylhexyl)thiuram disulfide (TOT), di-2-benzothiazolyl disulfide (MBTS), and the like.

The polar rubber layer 111 has elongation at break (Eb) preferably ≥500%, more preferably ≥800%, and further more preferably ≥1000%. Setting elongation at break (Eb) of the polar rubber layer 111 to be ≥500% enhances durability against repetitive deformation of a relatively large magnitude and suppresses crack generation and crack propagation speed, thereby further successfully improving crack propagation resistance of the polar rubber layer 111.

In the present disclosure, elongation at break (Eb) is a value measured according to JIS K 6251.

The non-polar rubber layer 112 has tensile stress at 100% elongation (M100) preferably ≥1.0 MPa, more preferably ≥1.5 MPa, and preferably ≤5.0 MPa. Provision of the non-polar rubber layer 112 having tensile stress at 100% elongation (M100)≥1.0 MPa successfully prevents excess expansion from occurring even when elongation at break (Eb) of the polar rubber layer 111 is ≥500%, thereby further improving durability of the actuator. The tensile stress at 100% elongation (M100)≤5.0 MPa ensures satisfactory functionality and operability of the actuator.

It is possible to manufacture the tube 110 having a laminated structure including the polar rubber layer 111 and the non-polar rubber layer 112 by, for example: blending the rubber components and the compounding agents described above, to prepare a rubber composition for a polar rubber layer and a rubber composition for a non-polar rubber layer, respectively; and subjecting these rubber composition to coextrusion by using an extrusion molding apparatus.

### EXAMPLES

The present disclosure will be described further in detail by Examples hereinafter. The present disclosure is not limited by any means to these Examples.

(Preparation of Rubber Composition)

A rubber composition was prepared by mixing and kneading by a Banbury mixer the rubber components and the compounding agents according to the blending formulations shown in Tables 1 and 2. Elongation at break (Eb) and tensile stress at 100% elongation (M100) were measured, respectively, by the methods described below for each of the rubber compositions thus obtained.

(1) Measurement of Tensile Stress at 100% Elongation (M100) and Elongation at Break (Eb)

Tensile stress at 100% elongation (M100) and elongation at break (Eb) were measured, respectively, by: subjecting each of the rubber compositions thus obtained to extrusion by 3-inch rolls and then vulcanizing press, thereby manufacturing a sheet-like body (width: 75 mm, length: 150 mm, thickness: 2 mm); preparing JIS K 6251 dumbbell-shaped No. 3 samples from the sheet-like body; and conducting tensile tests at 25° C. according to JIS K 6251, to measure tensile stress at 100% elongation (M100) and elongation at break (Eb) values of the samples. The results are shown in Table 1 and Table 2.

TABLE 1

| | | | | Polar | Polar | Polar | Polar | Polar | Polar | Polar | Polar |
|---|---|---|---|---|---|---|---|---|---|---|---|
| | | | | rubber | rubber | rubber | rubber | rubber | rubber | rubber | rubber |
| | | | | compo- | compo- | compo- | compo- | compo- | compo- | compo- | compo- |
| | | | | sition 1 | sition 2 | sition 3 | sition 4 | sition 5 | sition 6 | sition 7 | sition 8 |
| Formulations | Rubber | NBR1 (high nitrile content) *1 | Parts | 45 | 6 | 60 | 5 | 55 | — | 45 | 45 |
| | components | NBR2 (intermediate- | by mass | 35 | 64 | — | 55 | — | — | 35 | 35 |
| | | high nitrile content) *2 | | | | | | | | | |
| | | CR *3 | | — | — | — | — | — | 80 | — | — |
| | | BR1 *4 | | 20 | 30 | 40 | 40 | — | 20 | 20 | 20 |
| | | BR2 *5 | | — | — | — | — | — | — | — | — |
| | | NR *6 | | — | — | — | — | 45 | — | — | — |
| | | SBR *7 | | — | — | — | — | — | — | — | — |

| | | | | | | | | | | |
|---|---|---|---|---|---|---|---|---|---|---|
| | Carbon black 1 *8 | | — | — | — | — | — | — | — | — |
| | Carbon black 2 *9 | | 50 | 50 | 50 | 50 | 50 | 50 | 50 | 47 |
| | Carbon black 3 *10 | | — | — | — | — | — | — | — | — |
| | Carbon black 4 *11 | | — | — | — | — | — | — | — | — |
| | Stearic acid *12 | | 1 | 1 | 1 | 1 | 2 | 1 | 1 | 1 |
| | Anti-oxidant *13 | | 2 | 2 | 2 | 2 | 1.5 | 2 | 2 | 2 |
| | Resin *14 | | 10 | 10 | 10 | 10 | — | 10 | 10 | 10 |
| | Silica *15 | | — | — | — | — | — | — | — | 5 |
| | Silane coupling agent *16 | | — | — | — | — | — | — | — | — |
| | Plasticizer *17 | | 8 | 8 | 8 | 8 | — | 8 | 8 | 8 |
| | Zinc white *18 | | 5 | 5 | 5 | 5 | 5 | 5 | 5 | 5 |
| | Sulfur *19 | | 1 | 1 | 1 | 1 | 5 | 1 | 0.7 | 0.7 |
| | Vulcanization accelerator 1 *20 | | 1 | 1 | 1 | 1 | 1.5 | 1 | 1 | 1 |
| | Vulcanization accelerator 2 *21 | | — | — | — | — | — | — | — | — |
| | Vulcanization accelerator 3 *22 | | 2 | 2 | 2 | 2 | — | 2 | 2 | 2 |
| | Vulcanization accelerator 4 *23 | | — | — | — | — | — | — | — | — |
| | Vulcanization accelerator 5 *24 | | — | — | — | — | — | — | — | — |
| | Weighted average nitrile content | Mass % | 30.9 | 24.9 | 24.9 | 21.3 | 22.8 | — | 30.9 | 30.9 |
| | in rubber components | | | | | | | | | |
| Physical | Tensile stress at 100% elongation (M100) | MPa | 1.7 | 1.6 | 1.5 | 1.5 | 2.8 | 3 | 1.5 | 2.1 |
| properties | Elongation at break (Eb) | % | 530 | 550 | 560 | 560 | 650 | 450 | 540 | 548 |

| | | | | Polar | Polar | Polar | Polar | Polar | Polar |
|---|---|---|---|---|---|---|---|---|---|
| | | | | rubber | rubber | rubber | rubber | rubber | rubber |
| | | | | compo- | compo- | compo- | compo- | compo- | compo- |
| | | | | sition 9 | sition 10 | sition 11 | sition 12 | sition 13 | stion 14 |
| Formulations | Rubber | NBR1 (high nitrile content) *1 | Parts | 45 | 45 | 45 | 45 | 45 | 45 |
| | components | NBR2 (intermediate- | by mass | 35 | 35 | 35 | 35 | 35 | 35 |
| | | high nitrile content) *2 | | | | | | | |
| | | CR *3 | | — | — | — | — | — | — |
| | | BR1 *4 | | 20 | 20 | 20 | 20 | 20 | 20 |
| | | BR2 *5 | | — | — | — | — | — | — |
| | | NR *6 | | — | — | — | — | — | — |
| | | SBR *7 | | — | — | — | — | — | — |

| | | | | | | | | |
|---|---|---|---|---|---|---|---|---|
| | Carbon black 1 *8 | | — | — | — | — | — | — |
| | Carbon black 2 *9 | | 27 | — | 43 | 43 | 38 | 32 |
| | Carbon black 3 *10 | | — | 5 | — | — | — | — |
| | Carbon black 4 *11 | | — | — | — | — | — | — |
| | Stearic acid *12 | | 1 | 1 | 1 | 1 | 1 | 1 |
| | Anti-oxidant *13 | | 2 | 2 | 2 | 2 | 2 | 2 |
| | Resin *14 | | 10 | 10 | 10 | 10 | 10 | 10 |
| | Silica *15 | | 5 | 5 | 10 | 10 | 20 | 30 |
| | Silane coupling agent *16 | | — | — | — | 0.01 | — | — |
| | Plasticizer *17 | | 8 | 8 | 8 | 8 | 8 | 8 |
| | Zinc white *18 | | 5 | 5 | 5 | 5 | 5 | 5 |
| | Sulfur *19 | | 0.5 | 0.5 | 0.7 | 0.7 | 0.7 | 0.7 |
| | Vulcanization accelerator 1 *20 | | 0.7 | 0.7 | 1 | 1 | 1 | 1 |
| | Vulcanization accelerator 2 *21 | | — | — | — | — | — | — |
| | Vulcanization accelerator 3 *22 | | 1.3 | 1.3 | 2 | 2 | 2 | 2 |
| | Vulcanization accelerator 4 *23 | | — | — | — | — | — | — |
| | Vulcanization accelerator 5 *24 | | — | — | — | — | — | — |
| | Weighted average nitrile content | Mass % | 30.9 | 30.9 | 30.9 | 30.9 | 30.9 | 30.9 |
| | in rubber components | | | | | | | |
| Physical | Tensile stress at 100% elongation (M100) | MPa | 1.2 | 0.7 | 2.1 | 2.1 | 2.2 | 2.3 |
| properties | Elongation at break (Eb) | % | 832 | 1018 | 535 | 529 | 553 | 490 |

TABLE 2

| | | | | Non-polar | Non-polar | Non-polar | Non-polar | Non-polar |
|---|---|---|---|---|---|---|---|---|
| | | | | rubber | rubber | rubber | rubber | rubber |
| | | | | compo- | compo- | compo- | compo- | compo- |
| | | | | sition 1 | sition 2 | sition 3 | sition 4 | sition 5 |
| Formulations | Rubber | NBR1 (high nitrile content) *1 | Parts | — | — | — | — | — |
| | components | NBR2 (intermediate- | by mass | — | — | — | — | — |
| | | high nitrile content) *2 | | | | | | |
| | | CR *3 | | — | — | — | — | — |
| | | BR1 *4 | | — | — | — | — | |
| | | BR2 *5 | | — | — | — | 30 | 40 |
| | | NR *6 | | 100 | 100 | 100 | 70 | — |
| | | SBR *7 | | — | — | — | — | 60 |

| | | | | | | | |
|---|---|---|---|---|---|---|---|
| | Carbon black 1 *8 | | — | — | 50 | 50 | — |
| | Carbon black 2 *9 | | 50 | — | — | — | — |
| | Carbon black 3 *10 | | — | 50 | — | — | — |
| | Carbon black 4 *11 | | — | — | — | — | 50 |
| | Stearic acid *12 | | 2 | 2 | 2 | 2 | 2 |
| | Anti-oxidant *13 | | 1.5 | 1.5 | 1.5 | 1.5 | 1.5 |
| | Resin *14 | | — | — | — | — | — |
| | Silica *15 | | — | 2.0 | — | — | — |
| | Silane coupling agent *16 | | — | — | — | — | — |
| | Plasticizer *17 | | — | — | — | — | — |
| | Zinc white *18 | | 5 | 4 | 4 | 4 | 4 |
| | Sulfur *19 | | 5 | 1.5 | 1.5 | 1.5 | 1.5 |
| | Vulcanization accelerator 1 *20 | | 1.5 | 1.5 | 1.5 | 1.5 | 0.5 |
| | Vulcanization accelerator 2 *21 | | — | — | — | — | 0.5 |
| | Vulcanization accelerator 3 *22 | | — | — | — | — | — |
| | Vulcanization accelerator 4 *23 | | — | — | — | — | 0.5 |
| | Vulcanization accelerator 5 *24 | | — | — | — | — | — |
| | Weighted average nitrile content | Mass % | — | — | — | — | — |
| | in rubber components | | | | | | |
| Physical | Tensile stress at 100% elongation (M100) | MPa | 1.5 | 1.5 | 2.4 | 2.5 | 2 |
| properties | Elongation at break (Eb) | % | 700 | 690 | 480 | 485 | 650 |

| | | | | Non-polar | Non-polar | Non-polar | Non-polar |
|---|---|---|---|---|---|---|---|
| | | | | rubber | rubber | rubber | rubber |
| | | | | compo- | compo- | compo- | compo- |
| | | | | sition 6 | sition 7 | sition 8 | sition 9 |
| Formulations | Rubber | NBR1 (high nitrile content) *1 | Parts | — | 30 | 45 | — |
| | components | NBR2 (intermediate- | by mass | — | — | — | — |
| | | high nitrile content) *2 | | | | | |
| | | CR *3 | | — | — | — | — |
| | | BR1 *4 | | — | — | 55 | — |
| | | BR2 *5 | | — | — | — | — |
| | | NR *6 | | 100 | 70 | — | 100 |
| | | SBR *7 | | — | — | — | — |

| | | | | | | |
|---|---|---|---|---|---|---|
| | Carbon black 1 *8 | | — | — | — | — |
| | Carbon black 2 *9 | | — | 50 | 50 | 25 |
| | Carbon black 3 *10 | | 50 | — | — | — |
| | Carbon black 4 *11 | | — | — | — | — |
| | Stearic acid *12 | | 2 | 2 | 1 | 1 |
| | Anti-oxidant *13 | | 1.5 | 1.5 | 2 | 1.5 |
| | Resin *14 | | — | — | 10 | — |
| | Silica *15 | | 20 | — | — | — |
| | Silane coupling agent *16 | | 2 | — | — | — |
| | Plasticizer *17 | | — | — | 8 | — |
| | Zinc white *18 | | 4 | 5 | 5 | 5 |
| | Sulfur *19 | | 1.5 | 5 | 1 | 1.5 |
| | Vulcanization accelerator 1 *20 | | 1.5 | 1.5 | 1 | 0.7 |
| | Vulcanization accelerator 2 *21 | | — | — | — | — |
| | Vulcanization accelerator 3 *22 | | — | — | 2 | — |
| | Vulcanization accelerator 4 *23 | | — | — | — | — |
| | Vulcanization accelerator 5 *24 | | — | — | — | 0.2 |
| | Weighted average nitrile content | Mass % | — | 12.5 | 18.7 | — |
| | in rubber components | | | | | |
| Physical | Tensile stress at 100% elongation (M100) | MPa | 1.6 | 1.8 | 1.4 | 1 |
| properties | Elongation at break (Eb) | % | 690 | 650 | 670 | 758 |

*1 NBR1 (High nitrile): acrylonitrile-butadiene rubber, content of acrylonitrile unit=41.5 mass %, “N220S” manufactured by JSR Corporation, SP value=10.5 (cal/cm³)^{1/2}

*2 NBR2 (Intermediate-high nitrile): acrylonitrile-butadiene rubber, content of acrylonitrile unit=35 mass %, “N230S” manufactured by JSR Corporation, SP value=10.1 (cal/cm³)^{1/2}

*3 CR: chloroprene rubber, “Skyprene B-30” manufactured by Tosoh Corporation, SP value=8.9 (cal/cm³)^{1/2}

*4 BR1: vinyl cis-butadiene rubber (VC-BR), “UBEPOL® BR150” manufactured by Ube Industries, Ltd., content of cis-1,4 bond=98 mass %, SP value=8.3 (cal/cm³)^{1/2}

*5 BR2: butadiene rubber, “BR01” manufactured by JSR Corporation, SP value=8.3 (cal/cm³)^{1/2}

*6 NR: natural rubber, RSS#3, SP value=8.2 (cal/cm³)^{1/2}

*7 SBR: styrene-butadiene rubber, “#1500” manufactured by JSR Corporation, SP value=8.4 (cal/cm³)^{1/2}

*8 Carbon black 1: SAF-grade carbon black, N134, “SEAST 9H” manufactured by Tokai Carbon Co., Ltd., nitrogen adsorption specific surface area=145 m²/g

*9 Carbon black 2: HAF-grade carbon black, N330, “SEAST 3” manufactured by Tokai Carbon Co., Ltd., nitrogen adsorption specific surface area=79 m²/g

*10 Carbon black 3: HAF-grade carbon black, N326, “Asahi #70L” manufactured by Asahi Carbon Co., Ltd., nitrogen adsorption specific surface area=84 m²/g

*11 Carbon black 4: ISAF-grade carbon black, N234, “SEAST 7HM” manufactured by Tokai Carbon Co., Ltd., nitrogen adsorption specific surface area=126 m²/g

*12 Stearic acid: “STEARIC ACID 50S” manufactured by New Japan Chemical Co., Ltd.

*13 Anti-oxidant: “Nocrac 6C” manufactured by Ouchi Shiko Chemical industrial Co., Ltd.

*14 Resin: “Quintone 100” manufactured by Zeon Corporation

*15 Silica: “Nipsil AQ” manufactured by Tosoh Silica Corporation

*16 Silane coupling agent: “Si69” manufactured by Evonic Industries, AG

*17 Plasticizer: “SANSO CIZER DOA” manufactured by New Japan Chemical Co., Ltd.

*18 Zinc white: ZnO, “Zinc White No. 3” manufactured by Hakusui Tech Co., Ltd.

*19 Sulfur: “Sulfax Z” manufactured by Tsurumi Chemical Industry Co., Ltd.

*20 Vulcanization accelerator 1: vulcanization accelerator CBS, “Nocceler CZ” manufactured by Ouchi Shiko Chemical Industrial Co., Ltd.

*21 Vulcanization accelerator 2: vulcanization accelerator DPG, “Nocceler D” manufactured by Ouchi Shiko Chemical Industrial Co., Ltd.

*22 Vulcanization accelerator 3: vulcanization accelerator TOT, “Nocceler TOT-N” manufactured by Ouchi Shiko Chemical Industrial Co., Ltd.

*23 Vulcanization accelerator 4: vulcanization accelerator MTBS, “Nocceler DM” manufactured by Ouchi Shiko Chemical industrial Co., Ltd.

*24 Vulcanization accelerator 5: vulcanization accelerator DPG, “SOXINOL D-Z” manufactured by Sumitomo Chemical Co., Ltd.

(Preparation of Tube)

Test tubes each having a cylindrical configuration (length: 300 mm) were prepared by processing the rubber compositions thus obtained, by an extrusion molding machine, respectively. A tube having a two-layered structure constituted of an inner layer and an outer layer, as shown in FIG. 3, was prepared for each of Examples 1-27 and Comparative Examples 6, 7. A tube having a single-layer structure was prepared for each of Comparative Examples 1-5. The formulation of the rubber composition used in each outer/inner layer, the outer diameter and the inner diameter, a proportion of the inner layer thickness with respect to the tube thickness, and a proportion of the outer layer thickness with respect to the tube thickness, of each test tube, are shown in Table 3 and Table 4.

(Preparation of Sleeve)

Two aratnid fibers, each 2200 dtex, as raw yarns were subjected to first twist (12 times/10 cm) and then second twist (12 times/10 cm), whereby an aramid fiber cord having diameter: 0.7 mm was prepared. Test sleeves each having a woven structure were prepared by weaving the 64 aramid fiber cords thus obtained, respectively. Each test sleeve had a cylindrical, woven structure wherein the 64 aramid fiber cords were observed along a circumference of a cross section thereof. More specifically, each test sleeve had a cylindrical, woven structure constituted of one group of 32 aramid fiber cords disposed in parallel to each other at equal intervals therebetween to collectively form a spiral configuration and the other group of 32 aramid fiber cords disposed in parallel to each other at equal intervals therebetween to collectively form another spiral configuration so as to intersect the one group of 32 aramid fiber cords. The one group of 32 aramid fiber cords and the other group of 32 aramid fiber cords were woven to intersect each other alternately to collectively form the test sleeve. The angle formed by each cord with respect to the axis direction of the sleeve was 25°.

(Preparation of Actuator)

Test actuators each having the structures shown in FIGS. 1 and 2 were prepared by using the test tubes and the test woven sleeves described above, respectively. The length between the sealing mechanism 200 and a sealing mechanism 300 was 250 mm in each test actuator. “UF46” of COSMO SUPER EPOCH was used as hydraulic oil for the tube integrated in the test actuator. Durability of each of the test actuators thus prepared was evaluated by the methods described below. The results are shown in Tables 3 and 4.

<Method for Evaluating Durability of Actuator>

Durability of each test actuator was determined by: injecting the hydraulic oil into the tube and completely substituting air in the tube with the hydraulic oil; then controlling injection of the hydraulic oil such that the pressure of the hydraulic oil in the tube reciprocally changes between 0 MPa and 5 MPa in an alternate and repetitive manner at every 3 second; counting the number of injections until cracks were generated and propagated in the tube and the actuator could no longer function; and expressing the count number as an index value relative to the count number of Comparative Example 1 being “100” in Table 3 and as an index value relative to the count number of Example 25 being “100” in Table 4. The larger index value represents the higher durability (crack propagation resistance).

TABLE 3

| | | Example | Example | Example | Example | Example | Example | Example |
|---|---|---|---|---|---|---|---|---|
| | | 1 | 2 | 3 | 4 | 5 | 6 | 7 |
| Structure of tube | | Two- | Two- | Two- | Two- | Two- | Two- | Two- |
| | | layered | layered | layered | layered | layered | layered | layered |
| Formulation of inner layer | | Polar | Polar | Polar | Polar | Polar | Polar | Polar |
| rubber of tube | | rubber | rubber | rubber | rubber | rubber | rubber | rubber |
| | | composition 1 | composition 1 | composition 1 | composition 1 | composition 1 | composition 4 | composition 1 |
| Formuaton of outer layer | | Non-Polar | Non-Polar | Non-Polar | Non-Polar | Non-Polar | Non-Polar | Non-Polar |
| rubber of tube | | rubber | rubber | rubber | rubber | rubber | rubber | rubber |
| | | composition 1 | composition 2 | composition 3 | composition 4 | composition 5 | composition 1 | composition 1 |
| Outer diameter of tube | mm | 14 | 14 | 14 | 14 | 14 | 14 | 14 |
| Inner diameter of tube | mm | 10 | 10 | 10 | 10 | 10 | 10 | 10 |
| Proportion of inner layer | % | 50 | 50 | 50 | 50 | 50 | 50 | 20 |
| rubber thickness with | | | | | | | | |
| respect to tube thickness | | | | | | | | |
| Proportion of outer layer | % | 50 | 50 | 50 | 50 | 50 | 50 | 80 |
| rubber thickness with | | | | | | | | |
| respect to tube thickness | | | | | | | | |
| Evaluation of durability | Index | 281 | 530 | 488 | [7] | 250 | 452 | 309 |

| | | Example | Example | Example | Example | Example | Example |
|---|---|---|---|---|---|---|---|
| | | 8 | 9 | 10 | 11 | 12 | 13 |
| Structure of tube | | Two- | Two- | Two- | Two- | Two- | Two- |
| | | layered | layered | layered | layered | layered | layered |
| Formulation of inner layer | | Polar | Polar | Polar | Polar | Polar | Polar |
| rubber of tube | | rubber | rubber | rubber | rubber | rubber | rubber |
| | | composition 1 | composition 1 | composition 2 | composition 3 | composition 6 | composition 6 |
| Formuaton of outer layer | | Non-Polar | Non-Polar | Non-Polar | Non-Polar | Non-Polar | Non-Polar |
| rubber of tube | | rubber | rubber | rubber | rubber | rubber | rubber |
| | | composition 1 | composition 6 | composition 1 | composition 1 | composition 1 | composition 7 |
| Outer diameter of tube | mm | 14 | 14 | 14 | 14 | 14 | 14 |
| Inner diameter of tube | mm | 10 | 10 | 10 | 10 | 10 | 10 |
| Proportion of inner layer | % | 80 | 50 | 50 | 50 | 50 | 50 |
| rubber thickness with | | | | | | | |
| respect to tube thickness | | | | | | | |
| Proportion of outer layer | % | 20 | 50 | 50 | 50 | 50 | 50 |
| rubber thickness with | | | | | | | |
| respect to tube thickness | | | | | | | |
| Evaluation of durability | Index | 267 | 350 | 259 | 250 | 254 | 239 |

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| Structure of tube | | Single layer | Single layer | Single layer | Single layer | Single layer |
| Formulation of inner layer rubber of tube | | Polar rubber | Polar rubber | Polar rubber | Polar rubber | Non-Polar rubber |
| | | composition 1 | composition 2 | composition 3 | composition 4 | composition 1 |
| Formuaton of outer layer robber of tube | | — | — | — | — | — |
| Outer diameter of tube | mm | 14 | 14 | 14 | 14 | 14 |
| Inner diameter of tube | mm | 10 | 10 | 10 | 10 | 10 |
| Evaluation of durability | Index | 100 | 92 | 89 | 82 | 28 |

| | | Comp. | Comp. |
|---|---|---|---|
| | | Ex. 6 | Ex. 7 |
| Structure of tube | | Two-layered | Two-layered |
| Formulation of inner layer rubber of tube | | Non-Polar rubber | Polar rubber |
| | | composition 8 | composition 1 |
| Formuaton of outer layer rubber of tube | | Non-Polar rubber | Polar rubber |
| | | composition 1 | composition 5 |
| Outer diameter of tube | mm | 14 | 14 |
| Inner diameter of tube | mm | 10 | 10 |
| Proportion of inner layer | % | 50 | 50 |
| rubber thickness with | | | |
| respect to tube thickness | | | |
| Proportion of outer layer | % | 50 | 50 |
| rubber thickness with | | | |
| respect to tube thickness | | | |
| Evaluation of durability | Index | 69 | 60 |

TABLE 4

| | | Example | Example | Example | Example | Example |
|---|---|---|---|---|---|---|
| | | 14 | 15 | 16 | 17 | 18 |
| Structure of tube | | Two-layered | Two-layered | Two-layered | Two-layered | Two-layered |
| Formulation of inner layer rubber of tube | | Polar rubber | Polar rubber | Polar rubber | Polar rubber | Polar rubber |
| | | composition 8 | composition 9 | composition 10 | composition 11 | composition 12 |
| Formuaton of outer layer rubber of tube | | Non-Polar | Non-Polar | Non-Polar | Non-Polar | Non-Polar |
| | | rubber | rubber | rubber | rubber | rubber |
| | | composition 4 | composition 4 | composition 4 | composition 4 | composition 4 |
| Outer diameter of tube | mm | 16 | 16 | 16 | 16 | 16 |
| Inner diameter of tube | mm | 10 | 10 | 10 | 10 | 10 |
| Proportion of inner layer | % | 50 | 50 | 50 | 50 | 50 |
| rubber thickness with | | | | | | |
| respect to tube thickness | | | | | | |
| Proportion of outer layer | % | 50 | 50 | 50 | 50 | 50 |
| rubber thickness with | | | | | | |
| respect to tube thickness | | | | | | |
| Evaluation of durability | Index | 479 | 756 | 910 | 533 | 520 |
| | | Example | Example | Example | Example | Example |
| | | 19 | 20 | 21 | 22 | 23 |
| Structure of tube | | Two-layered | Two-layered | Two-layered | Two-layered | Two-layered |
| Formulation of inner layer rubber of tube | | Polar rubber | Polar rubber | Polar rubber | Polar rubber | Polar rubber |
| | | composition 13 | composition 8 | composition 8 | composition 8 | composition 10 |
| Formuaton of outer layer rubber of tube | | Non-Polar | Non-Polar | Non-Polar | Non-Polar | Non-Polar |
| | | rubber | rubber | rubber | rubber | rubber |
| | | composition 4 | composition 4 | composition 4 | composition 4 | composition 9 |
| Outer diameter of tube | mm | 16 | 16 | 16 | 16 | 16 |
| Inner diameter of tube | mm | 10 | 10 | 10 | 10 | 10 |
| Proportion of inner layer | % | 50 | 10 | 60 | 90 | 50 |
| rubber thickness with | | | | | | |
| respect to tube thickness | | | | | | |
| Proportion of outer layer | % | 50 | 90 | 40 | 10 | 50 |
| rubber thickness with | | | | | | |
| respect to tube thickness | | | | | | |
| Evaluation of durability | Index | 507 | 435 | 489 | 446 | 888 |

| | | Example | Example | Example | Example |
|---|---|---|---|---|---|
| | | 24 | 25 | 26 | 27 |
| Structure of tube | | Two-layered | Two-layered | Two-layered | Two-layered |
| Formulation of inner layer rubber of tube | | Polar rubber | Polar rubber | Polar rubber | Polar rubber |
| | | composition 7 | composition 7 | composition 7 | composition 14 |
| Fofmuaton of outer layer rubber of tube | | Non-Polar rubber | Non-Polar rubber | Non-Polar rubber | Non-Polar rubber |
| | | composition 3 | composition 4 | composition 4 | composition 3 |
| Outer diameter of tube | mm | 16 | 16 | 16 | 16 |
| Inner diameter of tube | mm | 10 | 10 | 10 | 10 |
| Proportion of inner layer | % | 50 | 95 | 5 | 60 |
| rubber thickness with | | | | | |
| respect to tube thickness | | | | | |
| Proportion of outer layer | % | 50 | 5 | 95 | 40 |
| rubber thickness with | | | | | |
| respect to tube thickness | | | | | |
| Evaluation of durability | Index | 123 | 100 | 111 | 102 |

It is understood from Table 3 that the hydraulic actuator according to the present disclosure has high durability.

Further, it is understood from Table 4 that durability of the hydraulic actuator further improves when the polar rubber layer contains silica and content of the silica is in the range of 5 to 20 parts by mass with respect to 100 parts by mass of the rubber components in the polar rubber layer.

### REFERENCE SIGNS LIST

10: Hydraulic actuator

20: Connection portion

100: Actuator main body

110: Tube

111: Polar rubber layer

112: Non-polar rubber layer

120: Sleeve

120a: First folded-back portion

120b: Sleeve main body

120c: Second folded-back portion

200, 200A, 200B, 200C: Sealing mechanism

210, 210A, 210B, 210C: Sealing member

211, 211A, 211B, 211C: Trunk portion

212, 212A: Flange portion

213: Irregular portions

214, 214B: First small diameter portion

215: Passage hole

216B: Second small diameter portion

220, 220A, 220B, 220C: First locking ring

230, 230A, 230B, 230C: Caulking member

231: Indentation

240: Adhesive layer

250, 250A: Rubber sheet

260: Rubber sheet

270, 270C: Second locking ring

280, 281: Rubber sheet

290, 291: Rubber sheet

300: Sealing mechanism

400: Fitting

410: Passage hole

D_{AX}: Axis direction

D_{R}: Radial direction

1. A hydraulic actuator, having an actuator main body constituted of a cylindrical tube capable of expanding/contracting by hydraulic pressure and a sleeve for covering an outer peripheral surface of the tube, the sleeve having a cylindrical structure formed by cords woven to be disposed in predetermined directions, wherein:
the tube has a laminated structure including two or more rubber layers, the rubber layers being constituted of at least one polar rubber layer containing, with respect to a rubber component(s) thereof, ≥50 mass % of a polar rubber of which SP value is ≥8.7 and at least one non-polar rubber layer containing, with respect to a rubber component(s) thereof, <50 mass % of a polar rubber of which SP value is ≥8.7.

2. The hydraulic actuator of claim 1, wherein the polar rubber layer is provided on the innermost side of the tube.

3. The hydraulic actuator of claim 1, wherein the non-polar rubber layer is provided on the outer side in the radial direction of the polar rubber layer and on the outermost side of the tube.

4. The hydraulic actuator of claim 1, wherein the polar rubber layer contains acrylonitrile-butadiene rubber and/or hydrogenated acrylonitrile-butadiene rubber.

5. The hydraulic actuator of claim 4, wherein the acrylonitrile-butadiene rubber and/or the hydrogenated acrylonitrile-butadiene rubber contains acrylonitrile units therein by 20 mass % to 50 mass %.

6. The hydraulic actuator of claim 4, wherein the acrylonitrile-butadiene rubber and/or the hydrogenated acrylonitrile-butadiene rubber include at least two types of acrylonitrile-butadiene rubber and/or hydrogenated acrylonitrile-butadiene rubber having different contents of acrylonitrile units therein.

7. The hydraulic actuator of claim 1, wherein the polar rubber layer contains a non-polar diene-based rubber having SP value less than 8.7.

8. The hydraulic actuator of claim 1, wherein the polar rubber layer has the weighted average nitrile content in the rubber component(s), which is in the range of ≥20 mass % and ≤45 mass %.

9. The hydraulic actuator of claim 1, wherein the non-polar rubber layer contains at least one selected from the group consisting of butadiene rubber, natural rubber, synthetic isoprene rubber, styrene-butadiene rubber, and butyl rubber.

10. The hydraulic actuator of claim 1, wherein the polar rubber layer and the non-polar rubber layer contain carbon black.

11. The hydraulic actuator of claim 10, wherein the carbon black contained in the non-polar rubber layer has the nitrogen adsorption specific surface area in the range of 34 m²/g to 155 m²/g.

12. The hydraulic actuator of claim 1, wherein the non-polar rubber layer further contains silica.

13. The hydraulic actuator of claim 12, wherein the non-polar rubber layer further contains a silane coupling agent.

14. The hydraulic actuator of claim 1, wherein the polar rubber layer further contains silica by 5 to 20 parts by mass with respect to 100 parts by mass of the rubber component(s) in the polar rubber layer.

15. The hydraulic actuator of claim 14, wherein the polar rubber layer contains a silane coupling agent by 0.1 parts by mass or less with respect to 100 parts by mass of the silica.

16. The hydraulic actuator of claim 1, wherein:
the total thickness of the polar rubber layer is 10% to 90% of the total thickness of the tube; and
the total thickness of the non-polar rubber layer is 90% to 10% of the total thickness of the tube.

17. The hydraulic actuator of claim 1, wherein the non-polar rubber layer has tensile stress at 100% elongation (M100) equal to or higher than 1.0 MPa.

18. The hydraulic actuator of claim 2, wherein the non-polar rubber layer is provided on the outer side in the radial direction of the polar rubber layer and on the outermost side of the tube.

19. The hydraulic actuator of claim 2, wherein the polar rubber layer contains acrylonitrile-butadiene rubber and/or hydrogenated acrylonitrile-butadiene rubber.

20. The hydraulic actuator of claim 2, wherein the polar rubber layer contains a non-polar diene-based rubber having SP value less than 8.7.
